(19) United States
(12) Patent Application Publication
(10) Pub. No.: US 2025/0369277 A1
(43) Pub. Date: Dec. 4, 2025

(54) UNITARY SKIN COMPRISING SDL BARS, DOOR COMPRISING THE SKIN, AND METHODS OF MAKING THE SAME

(71) Applicant: Plastpro 2000, Inc., Los Angeles, CA (US)

(72) Inventors: Shirley Wang, Los Angeles, CA (US); Scott Evert Johnson, Kingsville, OH (US); Sungste Lin, Rancho Palos Verdes, CA (US)

(21) Appl. No.: 19/222,629

(22) Filed: May 29, 2025

Related U.S. Application Data
(60) Provisional application No. 63/655,797, filed on Jun. 4, 2024.

(51) Int. Cl. E06B 3/58; E06B 3/78

(52) U.S. Cl. CPC E06B 3/5892; E06B 3/78

(57) ABSTRACT

A door skin, a door comprising at least one such a door skin, and a kit comprising at least one such a door skin are provided. The door skin is used to make a door comprising a glazing unit including one or more glass panes. The door skin includes a skin body portion providing an outer door surface. The skin body portion includes a set of simulated divided lite (SDL) bars, which may include one or more bars oriented in two different directions. The bars share at least one intersecting joint, which has an outer joint surface lower than the outer door surface relative to a bottom surface of the set of the SDL bars. The skin has a unitary structure. The set of SDL bars and the skin body portion are made of a same material. The door may include two door skins on both sides of the glazing unit.

### PRIORITY CLAIM AND CROSS-REFERENCE

This application claims the benefit of U.S. Provisional Application No. 63/655,797, filed Jun. 4, 2024, which application is expressly incorporated by reference herein in its entirety.

### FIELD

The disclosure relates to a door generally. More particularly, the disclosed subject matter relates to a skin comprising simulated divided lite (SDL) bars, a door comprising such a skin and a glazing unit, a kit comprising such a skin and a glazing unit, and the methods of making the skin and the door.

### BACKGROUND

A glazed door is a door comprising one or more glass panes or panels. The glass panes in a glazed door may be translucent or transparent, and provide desired decoration and optical clarity for the resulting door installed in residential and commercial buildings.

Fiberglass doors comprising synthetic polymers are used as substitutes for traditional wooden doors. Fiberglass doors include door skins (facings) secured to opposite sides of a rectangular door frame. A resulting cavity between the door skins and surrounded by the door frame optionally is filled with a core material. Doors so constructed can have wood graining printed, molded, or otherwise applied on the exterior surfaces of the door skins, and also raised paneling formed (e.g., molded) in the door skins. These features give the doors the appearance of natural wood fabricated products. Optionally, paint, stain, lacquer, and/or a protective layer may be applied to the exterior surface.

A traditional door or window may include multiple glass units divided by multiple pieces of bars, which may be made of wood. Such bars for supporting and dividing multiple glass units are called true divided light or lite (TDL) bars. Such panels may be referred to as true divided light, in that the glass panes were actually separate, individual pieces of glass. To avoid leaks in the windows and/or doors, the glass panels had to be cut and fitted to the bar grid with precision.

To simplify the manufacturing process, and to reduce the tendency for leaks to develop at the junction between the window pane and the bars, most manufacturers now use a grid of interlocking bars applied to the exterior surface of a single glass pane so as to seemingly divide a single large window pane into multiple smaller panes. Such structures may be referred to as simulated divided light (SDL) structures. One glass pane may be used to provide a window or door having SDL structures. The bars are applied to a surface of the transparent glass panel to thereby divide the surface of the glass pane. Such bars are called simulated divided light or lite (SDL) bars. The SDL bars provide aesthetic appearance to the door or windows.

The existing SDL bars are made separately, for example, using an extrusion process. The extruded SDL bars are cut and assembled together after a glass unit is installed in a door. The manufacturing process includes many steps, and is time-consuming and costly. After the SDL bars are installed, gaps exists between the SDL bars and the glass unit. Dirt may be trapped inside such a door. The SDL bars are made of a material different from that of other components such as a skin or frame of a door. After exposed to sun light or heat, the SDL bars discolor to show a mismatching color, and shrink and then fall off from the door.

Therefore, there is a need for SDL bars with easy installation, good performance, and high durability. One of the objectives in the present disclosure is to provide products and methods to solve the problems described above.

### SUMMARY

The present disclosure provides a door skin comprising simulated divided lite (SDL) bars, a door comprising at least one such a skin and a glazing unit, and the methods of making the skin and the door. The present disclosure also provides a kit for making such a door. The kit comprises at least one such a skin and a glazing unit. More particularly, the present disclosure provides a unitary skin comprising SDL bars. The SDL bars are part of the unitary structure of the skin, are made of the same material for the skin, and have the features as described herein. In some embodiments, the door comprises two skins, which form an interior interlocking structure. The glazing unit is assembled with the skins in some embodiments.

In some embodiments, the door comprises a first skin, a second skin, and a glazing unit. The first skin includes a first skin body portion providing a first outer (e.g., exterior) door surface. The first skin body portion has a first tip (or end), and comprises a first set of simulated divided lite (SDL) bars connected with the first tip. The second skin includes a second skin body portion providing a second outer (e.g., exterior) door surface. The second skin body portion has a second tip, and comprises a second set of SDL bars connected with the second tip.

The glazing unit comprises one or more glass panes, and has an edge disposed adjacent to, and between, the first tip and the second tip, and between the first set of SDL bars and the second set of SDL bars.

Each of the first set of the SDL bars and the second set of the SDL bars comprises one or more first bars oriented in a first direction and one or more second bars oriented in a second direction different from the first direction. The one or more first bars and the one or more second bars share at least one intersecting joint, which has an outer joint surface lower than the first outer door surface relative to the glazing unit. Each of the first skin and the second skin has a unitary structure. The first set of SDL bars and the first skin body portion are made of a same material. The second set of SDL bars and the second skin body portion are made of the same material.

In some embodiments, in each of the first set of the SDL bars and the second set of the SDL bars, the second direction is normal to the first direction. Each of the first set of the SDL bars and the second set of the SDL bars is in a grid pattern.

The first set of the SDL bars and the second set of the SDL bars are of a same size and a same pattern, and are configured to match with each other on two sides of the glazing unit so as to define one or more lite sections for exposing the one or more glass panes in the glass unit. The first skin and the second skin may be identical.

In some embodiments, each of the first set of the SDL bars and the second set of the SDL bars has a profile with a gradual decrease in a bar surface relative to the glazing unit (or a bottom surface of the SDL bars) from the outer joint surface to the outer joint door surface. The bottom surface of the SDL bars contacts the glazing unit.

The first skin may further comprise a first flange portion connected with and extending inwardly from the first skin body portion. The second skin may further comprise a second flange portion connected with and extending inward from the second skin body portion. The first flange portion and the second flange portion have a protrusion or recess at each end and are interconnected so as to provide at least one interlocking structure. In some embodiments, the first flange portion has alternating protrusions and recesses, the second flange portion has corresponding alternating recesses and protrusion, and the at least one interlocking structure comprises alternating male/female interlocking structures.

In some embodiments, each of the first skin and the second skin comprises a glass fiber filled polymer composite, and may be made of a sheet molded compound (CMC) molded under compression.

In another aspect, the present disclosure provides a door skin as described herein, which is configured to be used for making a door. The door comprises a glazing unit including one or more glass panes. Such as a door skin, for example, a first door skin, comprises a first skin body portion providing a first outer door surface. The first skin body portion has a first tip and comprises a first set of simulated divided lite (SDL) bars connected with the first tip. The first tip and the first set of SDL bars are configured to be disposed adjacent to and contact the glazing unit. The first set of the SDL bars comprises one or more first bars oriented in a first direction and one or more second bars oriented in a second direction different from the first direction. The one or more first bars and the one or more second bars share at least one intersecting joint, which has an outer joint surface lower than the first outer door surface relative to a bottom surface of the first set of the SDL bars. The first skin has a unitary structure. The first set of SDL bars and the first skin body portion are made of a same material.

In some embodiments, the second direction is normal to the first direction, and the first set of the SDL bars is in a grid pattern. In some embodiments, the first set of the SDL bars has a profile with a gradual decrease in a bar surface relative to the glazing unit from the outer joint surface to the outer joint door surface. The first skin comprises a glass fiber filled polymer composite. In some embodiments, the first skin is made of a sheet molded compound (CMC) molded under compression.

The present disclosure also provides a skin structure as described. The descriptions for the first skin is also applicable to the second skin.

In another aspect, the present disclosure also provides a kit for making a door as described herein. Such a kit comprises a first skin, a second skin, and a glazing unit. The first skin includes a first skin body portion providing a first outer door surface, has a first tip, and comprises a first set of simulated divided lite (SDL) bars connected with the first tip. The second skin includes a second skin body portion providing a second outer door surface, has a second tip, and comprises a second set of SDL bars connected with the second tip. The glazing unit includes one or more glass panes. The glazing unit has an edge shaped and sized to be disposed adjacent to, and between, the first tip and the second tip, and between the first set of SDL bars and the second set of SDL bars.

In some embodiments, each of the first set of the SDL bars and the second set of the SDL bars comprises one or more first bars oriented in a first direction and one or more second bars oriented in a second direction different from the first direction. The one or more first bars and the one or more second bars share at least one intersecting joint, which has an outer joint surface lower than the first outer door surface relative to a bottom surface of each corresponding set of the SDL bars.

Each of the first skin and the second skin has a unitary structure. The first set of SDL bars and the first skin body portion are made of a same material. The second set of SDL bars and the second skin body portion are made of the same material.

In some embodiments, in each of the first set of the SDL bars and the second set of the SDL bars, the second direction is normal to the first direction, and each of the first set of the SDL bars and the second set of the SDL bars is in a grid pattern.

The first set of the SDL bars and the second set of the SDL bars are of a same size and a same pattern, and are configured to match with each other on two sides of the glazing unit so as to define one or more lite sections for exposing the one or more glass panes in the glass unit.

In some embodiments, the first skin further comprises a first flange portion connected with and extending inwardly from the first skin body portion. The second skin further comprises a second flange portion connected with and extending inwardly from the second skin body portion. The first flange portion and the second flange portion have a protrusion or recess at each end and are interconnected so as to provide at least one interlocking structure.

In some embodiments, each of the first skin and the second skin comprises a glass fiber filled polymer composite. Each of the first skin and the second skin is made of a sheet molded compound (CMC) molded under compression.

In another aspect, the present disclosure provides a method for making a door as described herein. The method comprises steps of providing a first skin as described, providing a second skin as described, installing the glazing unit between the first skin and the second skin, and connecting the first skin and the second skin so as to provide a door comprising SDL bars and the glazing unit.

In some embodiments, the first or second skin is provided by molding the first or second skin, including the respective skin body portion and a respective middle portion, in a unitary structure. The middle portion is then cut to provide SDL bars. In some embodiments, each of the first skin and the second skin is molded from a glass fiber filled polymer composite. Each of the first skin and the second skin is made of a sheet molded compound (CMC) molded under compression.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion. Like reference numerals denote like features throughout specification and drawings.

The attached design drawings illustrate exemplary doors in accordance with some embodiments.

FIG. 1 is a plan view illustrating an exemplary door or (skin) in accordance with some embodiments.

FIG. 2 is a plan view illustrating another exemplary door (or skin) in accordance with some embodiments.

FIG. 3 is a sectional view illustrating the exemplary door of FIG. 1 or FIG. 2 comprising an interlocking structure formed by a first skin and a second skin in accordance with some embodiments.

FIGS. 4A-4B are sectional views illustrating an exemplary first skin and an exemplary second skin in accordance with some embodiments. FIG. 4A shows an exemplary second skin, and FIG. 4B shows an exemplary first skin.

FIG. 5 is a perspective view illustrating an exemplary skin having both male and female flange portions in accordance with some embodiments.

FIGS. 6A-6B are sectional views illustrating an exemplary skin, one of the first and the second skins, having unitary structure and comprising SDL bars, in accordance with some embodiments.

FIGS. 7 and 8 are sectional views illustrating an exemplary skin of FIGS. 6A-6B in one embodiment. FIGS. 7-8 are sectional views along A-A′ and B-B′ as shown in FIG. 6A, respectively.

FIGS. 9A and 9B are sectional views illustrating the exemplary skin of FIGS. 6A-6B in accordance with some embodiments. FIGS. 9A-9B are sectional views along A-A′ and B-B′ as shown in FIG. 6A, respectively.

FIGS. 9C and 9D are magnified views illustrating a portion of the exemplary skin of FIGS. 9A-9B in accordance with some embodiments.

FIG. 10 is a sectional view illustrating a molded piece to be cut to provide the exemplary skin in accordance with some embodiments.

FIG. 11 illustrates an exemplary method for making a door in accordance with some embodiments.

FIG. 12 illustrates an exemplary method for making the exemplary skin in accordance with some embodiments.

### DETAILED DESCRIPTION

implementing different features of the invention. Specific examples of components and arrangements are described below to simplify the present disclosure. These are, of course, merely examples and are not intended to be limiting. For example, the formation of a first feature over or on a second feature in the description that follows may include embodiments in

The following disclosure provides many different embodiments, or examples, for which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the present disclosure the singular forms “a,” “an,” and “the” include the plural reference, and reference to a particular numerical value includes at least that particular value, unless the context clearly indicates otherwise. Thus, for example, a reference to “an interlocking structure” is a reference to one or more of such structures and equivalents thereof known to those skilled in the art, and so forth. When values are expressed as approximations, by use of the antecedent “about,” it will be understood that the particular value forms another embodiment.

As used herein, “about X” (where X is a numerical value) preferably refers to +10% of the recited value, inclusive. For example, the phrase “about 8” preferably refers to a value of 7.2 to 8.8, inclusive; as another example, the phrase “about 8%” preferably (but not always) refers to a value of 7.2% to 8.8%, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

Unless expressly indicated otherwise, references to “substantially normal (or perpendicular) to” made herein will be understood to encompass an intersection having an angle of about 90 degree, for example, in the range of from 81 to 99 degree.

References to “a glazing unit” made herein will be understood to encompass a unit comprising one or more panes or panels made of an inorganic glass, organic glass, or a combination thereof. A glazing unit is also known a glazing, a glass unit, or a glass insert. A glazing unit or a glass unit may comprises at least two glass panes (or panels) oriented in parallel, which define a cavity between the two glass panes. A door may comprise one or more glazing units, each of which is referred as one pane, when viewed from a front or back surface of the door. So a door may include one or multiple panes.

As described herein, unless expressly pointed out otherwise, the term “light” or “lite” are used interchangeably. For example, a simulated divided light bar is also called as a simulated divided lite bar, and is abbreviated as SDL bar. The SDL bars are muntin bars applied to an exterior surface of one transparent glass pane to thereby divide the surface of the glass pane. The SDL bars divide one corresponding glass pane into different sections, which are in regular shapes such as rectangle or square. Each of such sections is where the glass pane can be seen through and is referred as “light” or “lite.” In some embodiments, the SL bars in the door skin provided in the present disclosure are used as exterior SDL bars.

The present disclosure provides a door skin comprising simulated divided lite (SDL) bars, a door comprising at least one such a skin and a glazing unit, and the methods of making the skin and the door. The present disclosure also provides a kit for making such a door. The kit comprises at least one such a skin and a glazing unit. More particularly, the present disclosure provides a unitary door skin comprising one or more SDL bars. The SDL bars are part of the unitary structure of the skin. The SDL bars and other portion of the skin are made of the same material. The door skin has the features as described herein. In some embodiments, the door comprises two skins. The glazing unit is assembled with the skins in some embodiments. The two skins form an interlocking structure inside the door.

In addition to decoration purposes, the SDL bars in the unitary structure of the skin provided in the present disclosure also provide structural reinforcement and protection to the glass unit. For example, the SDL bars provides compression onto a glass pane in the glass unit.

The following descriptions are additional to the description in the Summary and the attached drawings. These do not exhaust the written descriptions based all the drawings. The exemplary embodiments are illustrated in the attached drawings.

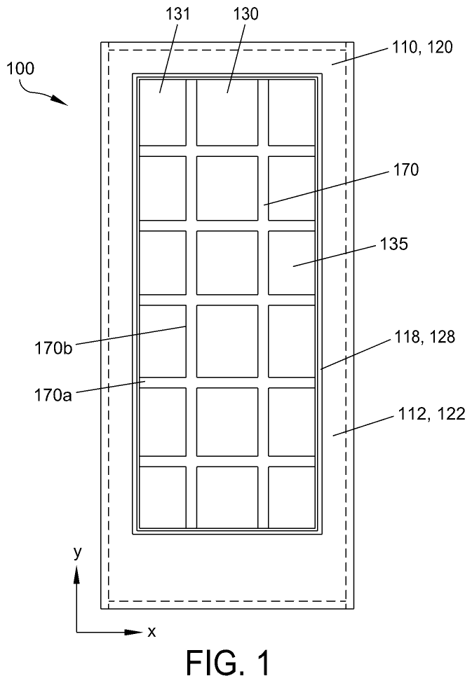

Referring to FIGS. 1-3, an exemplary door 100 comprises two skins including a first skin 110, a second skin 120, and a glazing unit 130. Each of the skins 110, 120 has a main body portion in the form of the front or back surface of the exemplary door and may have a flange portion connected with the main body portion (i.e. the surface portion). The first skin 110 includes a first skin body portion 112 providing a first outer (e.g., exterior) door surface 114. The second skin 120 includes a second skin body portion 122 providing a second outer (e.g., exterior) door surface 124. Each skin also comprises a tip 118, 128 as described herein.

Each of the skins 110, 120 defines at least one opening 131 in its planar body portion for receiving and/or exposing the glazing unit 130. In some embodiments, the openings 131 in the skins 110, 120 have a same size. The two skins 110, 120 combined also define an opening 131 for the glazing unit 130 at the tips 118, 128. Each tip as described herein can be considered as a tip line or edge along the opening 131 for accepting the glazing unit 130, which comprises at least two glass panes.

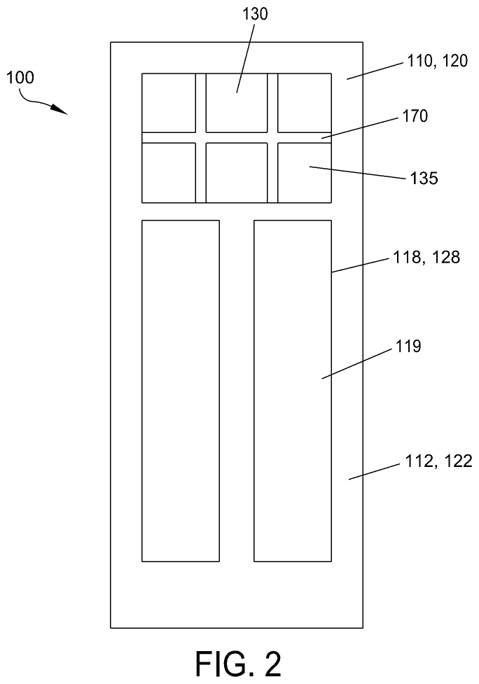

As shown in FIGS. 1-2, in addition to the skin body portion 112 and 122, each skin 110, 120 comprises one or more simulated divided lite (SDL) bars 170. The first skin body portion 112 has a first tip 118 (or end), and comprises a first set of simulated divided lite (SDL) bars 170 connected with the first tip 118. The second skin body portion 122 has a second tip 128, and comprises a second set of SDL bars 170 connected with the second tip 128.

The glazing unit 130 comprises one or more glass panes, and has an edge disposed adjacent to, and between, the first tip 118 and the second tip 128, and between the first set of SDL bars and the second set of SDL bars 170.

The SDL bars 170 and the other portion of each skin 112, 122 are molded in a unitary structure and made of the same materials. The SDL bars 170 are bars applied to an exterior surface of one transparent glass pane to thereby divide the surface of the glass pane 130. The SDL bars divide one corresponding glass pane 130 into different sections 135, which are in regular shapes such as rectangle or square. Each of such divided sections 135 is where the glass pane 130 can be seen through and is referred as “light” or “lite.”

For the purpose of illustration only, the door 100 (or a skin 110, 120) illustrated in FIG. 1 is configured to fit one glass unit 130, and comprises 15 divided sections 135 (i.e., 15 lites). The door 100 (or skin 110, 120) illustration in FIG. 2 is configured to fit one glass unit 130 on the top section, and comprises 6 divided sections 135 (i.e., 6 lites). The door 100 (or skin 110, 120) illustration in FIG. 2 comprises two concaved and opaque sections 119 at the bottom portion. The sections 119 can be also cut out to form more SDL bars and openings for installing additional glazing units 130. These configurations are made for illustration only. A skin or door provided in the present disclosure may comprise any combination of the number of the opening 131 for glazing units 130, the number of the SDL bars, and the dimension of the SDL bars.

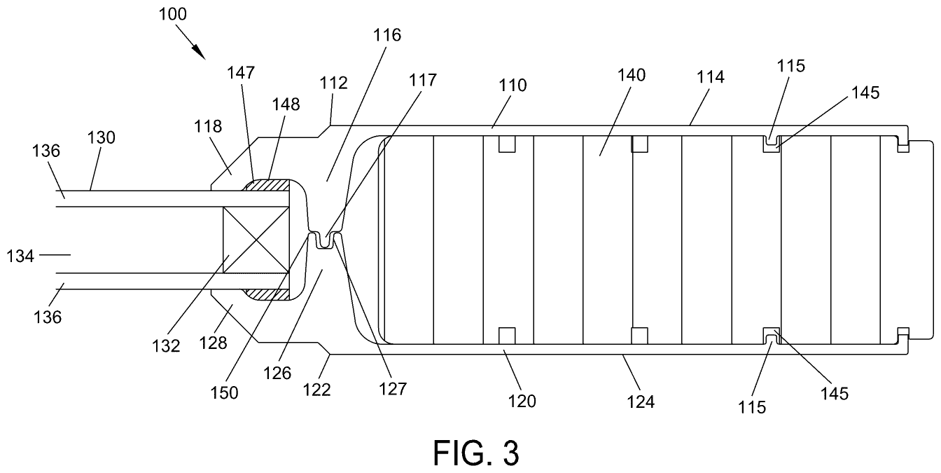

For example, referring to FIG. 3, in some embodiments, the first skin 110 includes a first skin body portion 112 providing a first outer (e.g., exterior) door surface 114, and a first flange portion 116 connected with and extending inward from the first skin body portion 112. The first skin body portion has a first tip (or end) 118. The second skin 120 includes a second skin body portion 122 providing a second outer (e.g., exterior) door surface 124 and a second flange portion 126 connected with, and extending inwardly from, the second skin body portion 122. The second skin body portion 122 has a second tip 128. Each tip 118, 128 has a contact surface configured to hold and the glazing unit 130.

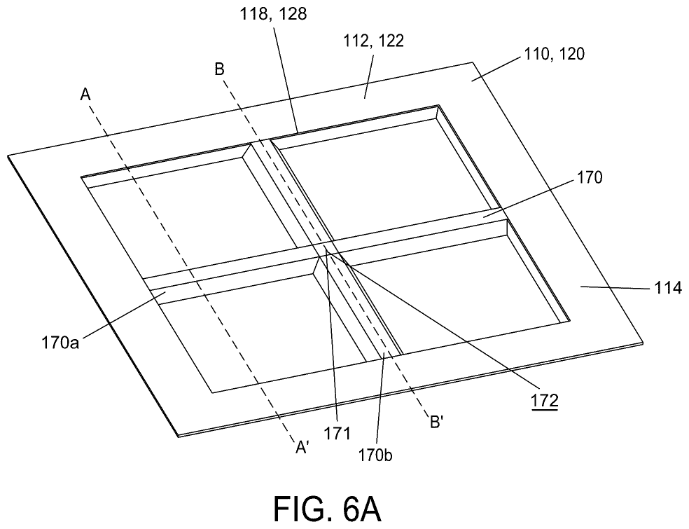

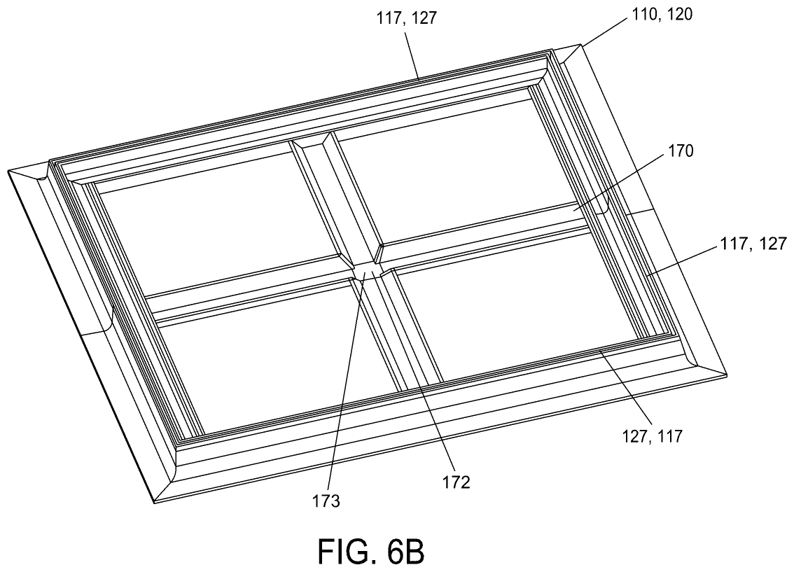

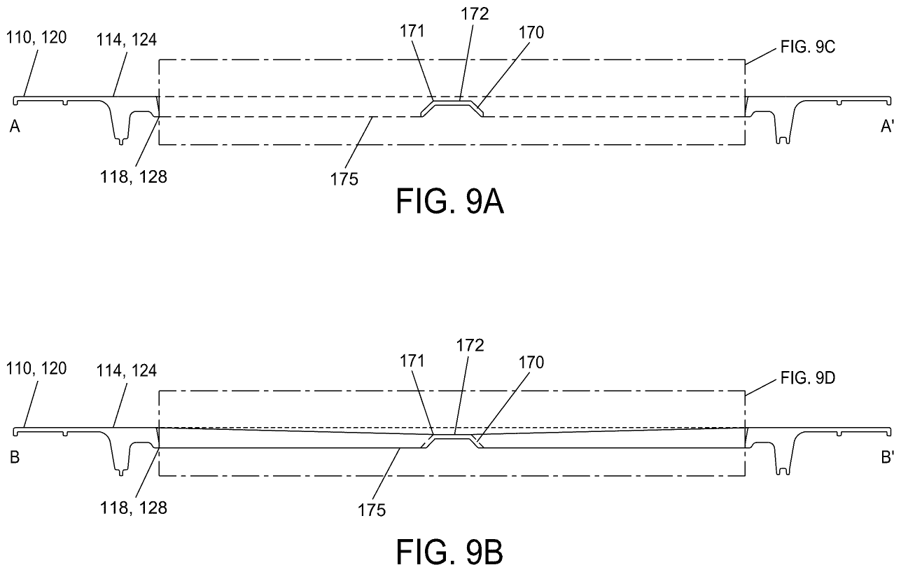

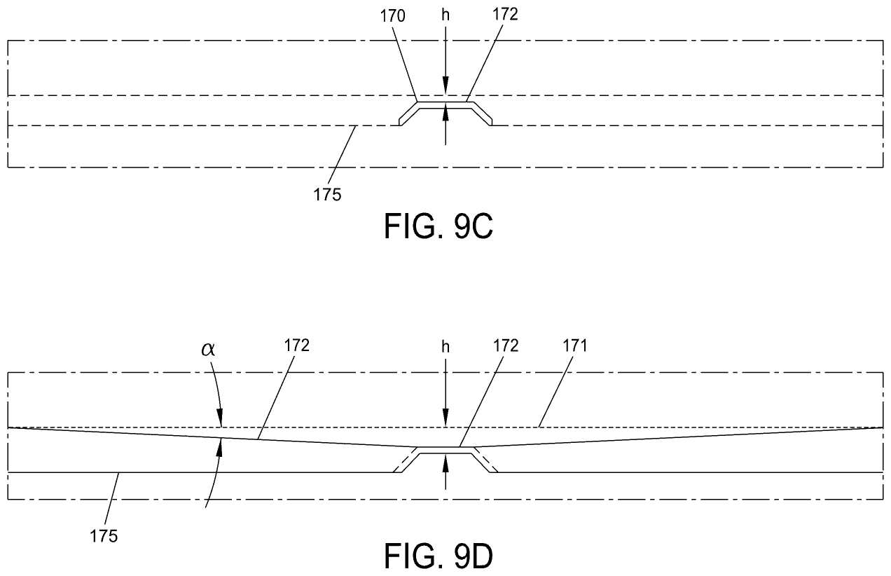

In the exemplary door as illustrated in FIG. 3, each of the first skin and the second skin comprises SDL bars as described below in FIGS. 1-2, 6A-6B, and 9A-9D. Each of the first skin and the second skin comprises a set of SDL bars 170 connected to each respective tip 118 and 128. In some embodiments, each of the first set of the SDL bars and the second set of the SDL bars 170 comprises one or more first bars 170a oriented in a first direction 170a (shown in the x-direction in FIG. 1) and one or more second bars 170b oriented in a second direction (as shown in the y-direction in FIG. 1) different from the first direction. As described in FIGS. 6A-6B, and 9A-9D, the one or more first bars and the one or more second bars shares at least one intersecting joint, which has an outer joint surface lower than the first outer door surface relative to the glazing unit. In some embodiments, each of the first set of the SDL bars 170 and the second set of the SDL bars 170 has a profile with a gradual decrease in a bar surface relative to the glazing unit (or a bottom surface of the SDL bars) from the outer joint surface to the outer joint door surface. The bottom surface of the SDL bars contacts the glazing unit.

In some embodiments, as illustrated in FIGS. 1-2, in each of the first set of the SDL bars and the second set of the SDL bars, the second direction (y) is normal to the first direction (x). Each of the first set of the SDL bars and the second set of the SDL bars is in a grid pattern.

The first set of the SDL bars 170 and the second set of the SDL bars 170 are of a same size and a same pattern, and are configured to match with each other on two sides of the glazing unit so as to define one or more lite sections for exposing the one or more glass panes in the glass unit. The first skin 110 and the second skin 120 may be identical, except that the two skins have different but matching protrusions and recesses for the interlocking structures.

Both skins having SDL bars are described for illustration only. In some embodiments, only one of the two skins has SDL bars while the other skin may only define an opening without SDL bars. The grid-pattern of the SDL bars are also described for illustration only. The SDL bars may have other patterns. For example, in some embodiments, the SDL bars in the door skins have at least one diamond shape, or at least one circle shape, or any combination thereof, including any combination of a diamond shape, a circle shape, a square, and a rectangle shape.

The glazing unit 130 comprises one or more panes 136 (or panels) and has an edge disposed adjacent to and between the first tip 118 and the second tip 128. The glazing unit 150 may include a spacer 132 and a void 134 between two adjacent glass panes 136. In some embodiments, the glazing unit 130 comprises multiple panes 136, which include or are made of inorganic or organic glass, or a combination thereof. For example, the glazing unit 130 may comprise two panes 136 and a spacer 132 between the two panes 136.

In some embodiments, the glazed unit 130 may include a plurality of panes 136, including first and second panes, which establish the opposite first and second sides of the glazed unit 130. The glazed unit also may include a spacer 132 disposed between the first and second panes 136. The spacer 132 may extend adjacent each edge of the first and second panes 136. Each of the plurality of panes 136 comprises inorganic glass, organic glass, or a combination thereof. In some embodiments, each pane comprises or is made of silica or silicate based glass such as soda-lime glass. Unless expressly indicated otherwise, references to “organic glass” made herein will be understood to encompass unless any amorphous, solid, glasslike material made of transparent plastic, including but not limited to, polycarbonate, and polymethyl methacrylate (PMMA).

The first flange portion 116 and the second flange portion 126 have ends of complementary shapes and sizes, and are interconnected to provide an interlocking structure 150. For example, the flange portions 116, 126 of the two skins 110, 120 face each other and form a male-female interlocking structure 150. On the other side of the interlocking structure 150 opposite to the glazing unit 130, the main body portions 112, 122 and the flange portions 116, 126 form a cavity, which is filled with a foamed material 140. The first flange portion 116 and the second flange portion 126 have a protrusion or recess at each end and are interconnected so as to provide at least one interlocking structure 150. In some embodiments, the first flange portion 116 has alternating protrusions and recesses, the second flange portion 126 has corresponding alternating recesses and protrusion, and the at least one interlocking structure comprises alternating male/female interlocking structures.

Each of the skins 110, 120 may have interior ribs or studs 115 on the interior surfaces protruding into cavities 145 defining by the foamed material 140. In some embodiments, the foamed material 140 is made of polyurethane (PU) foam, which is disposed between the first skin 110 and the second skin 120. The foamed material 140 and the glazing unit 130 are disposed on two sides separated by the interlocking structure 150.

Each of the flange portion 116, 126 may be unitarily molded with a respective skin 110, 120 or bonded onto the skin 110, 120. In some embodiments, the first skin 110 including the first skin body portion 112 and the first flange portion 116 is a unitary molded structure. The second skin 120 including the second skin body portion 122 and the second flange portion 126 is a unitary molded structure. In some other embodiments, each respective flange portion 116, 126 and the respective skin body portion 112, 122 may be molded separately and then bonded together. The first flange portion 116 is bonded with the first skin body portion 112 in the first skin 110, and the second flange portion 126 is bonded with the second skin body portion 122 in the second skin 120.

In some embodiments, the first flange portion 116 and the second flange portion 126 for the interlocking structure 150 comprise a material selected from the group consisting of a glass fiber polymer composite, a polymer (e.g., PVC), a metal, wood, and any combination thereof.

In some embodiments, each of the first skin 110 and the second skin 120 including all the components comprises a glass fiber filled polymer composite, and may be made of a sheet molded compound (CMC) molded under compression. In some embodiments, the door skins, referred as fiberglass door skins, are formed of sheet molding compound (or SMC) sheets containing resinous sheets reinforced with fiberglass, often chopped fiberglass or fiberglass mats. A thermoplastic polymer is included in the fiberglass door skins.

In some embodiments, each of the first skin 110 and the second skin 120 has an inner surface defining a groove 147 for accepting an adhesive or sealant 148, which bonds or seals one portion of the skin with the corresponding portion of the panes 136 in the glazing unit 130. As shown in FIG. 3, the adhesive or sealant 148 may be also disposed between the first or second flange portion 116, 126 and the glazing unit 130. In some embodiments, an adhesive or sealant 148 is disposed between the end of the first flange portion 116 and the end of the second flange portion 126 in the interlocking structure 150. The adhesive or sealant 148 is cured in an assembled door. In some embodiments, the interlocking structure 150 is mechanically formed without any adhesive or sealant between the first and the second flange portion 116, 126.

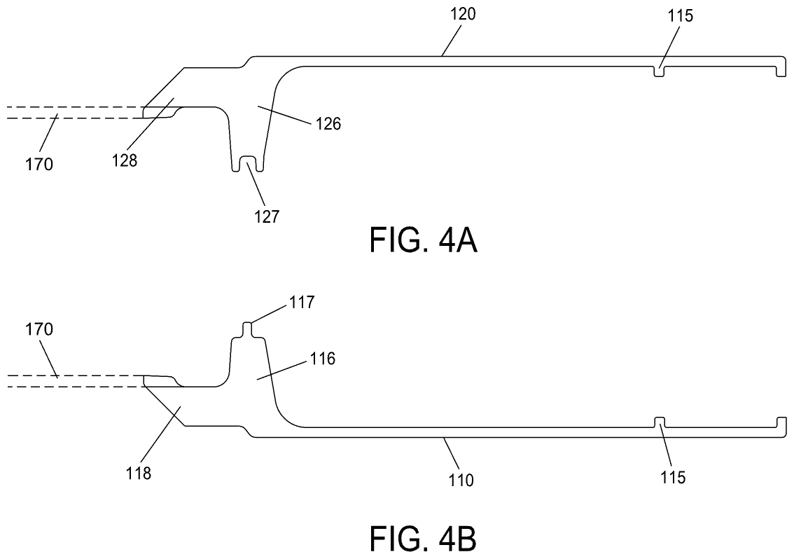

FIGS. 4A-4B illustrate an exemplary first skin 110 (FIG. 4B) and an exemplary second skin 120 (FIG. 4A) in accordance with some embodiments. In the first skin 110, the first flange portion 116 comprises a first protrusion 117. In the second skin 120, the second flange portion 126 defines a first recess 127 for accepting the first protrusion 117, or vice versa. The first flange portion 116 and the second flange portion 126 can be interconnected during assembly to form the male/female interlocking structure 150 as illustrated in FIG. 3.

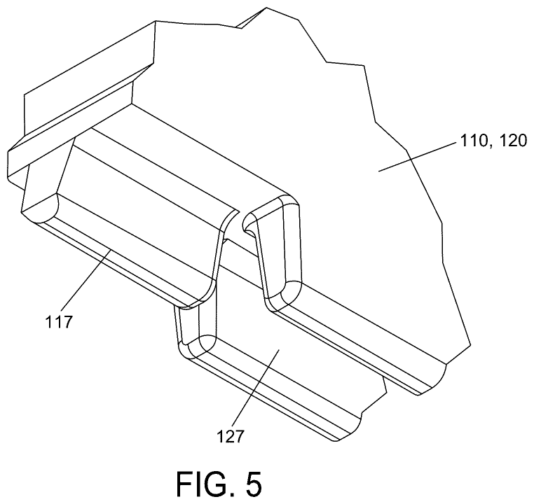

Referring to FIG. 5, in some embodiments, each flange portion of the skins 110, 120 comprises both protrusion 117 and recess 127, which match with each other along edges of the skins 110, 120 defining the opening 131 for the glazing unit 150. For example, the second flange portion 126 also has at least one portion comprising a second protrusion 117. The first flange portion has a corresponding portion defining a second recess 127 for accepting the second protrusion. The first flange portion 116 and the second flange portion 126 are interconnected through alternating male/female interlocking structures 150. These interlocking structures 150 exist around the edge of the openings 131 in some embodiments.

Referring to FIGS. 3 and 4A-4B, in some embodiments, the first flange portion 116 of the first skin 110 is substantially normal to the first skin body portion 112. The second flange portion 126 of the second skin 120 is also substantially normal to the second skin body portion 122. In some embodiments, each skin 110 or 120 has a large central opening 131 with an inwardly directed flange 116 or 126 extending normal to its planar surface 114 or 124. The openings 131 have the same size, slightly smaller than the size of glass panes 136. The two skins 110, 120 may be placed parallel to each other during assembly.

In some embodiments, the skins 110, 120 may be cut out to have two or three openings 131. One of ordinary skill in the art will understand that the number of cutouts may vary.

FIGS. 6A-6B, 7, 8, and 9A-9D illustrate an exemplary door skin as described herein. FIGS. 6A-6B and 9A-9D illustrate the preferred door skins in accordance with some embodiment. The door skin is used for making a door comprising a glazing unit, which includes one or more glass panes. Such as a door skin, for example, the first door skin 110 or the second door skin 120 as described herein. The two door skins can be the same, except the flanges for forming the interlocking structure. The descriptions for the first skin are also applicable to the second skin.

Referring to FIGS. 6A-6B, the first door skin 110 is described for illustration only. The first door skin 110 comprises a first skin body portion 112 providing a first outer door surface 114. The first skin body portion 112 has a first tip 118 and comprises a first set of simulated divided lite (SDL) bars 170 connected with the first tip 118. The first tip 118 and the first set of SDL bars 170 are configured to be disposed adjacent to and contact the glazing unit 130. The first set of the SDL bars 170 comprises one or more first bars 170a oriented in a first direction and one or more second bars 170b oriented in a second direction different from the first direction. The one or more first bars 170a and the one or more second bars 170b share at least one intersecting joint 172. The at least one intersecting joint 172 has an exterior surface 171, which on the same side as the first exterior surface 114 of the door, and an interior surface 173, which faces the glazing unit 130.

The first skin 110 has a unitary structure. The first set of SDL bars 170 and the first skin body portion 112 are made of a same material. In some embodiments, the second direction is normal to the first direction, and the first set of the SDL bars 170 is in a grid pattern. In some embodiments, the first skin 110 comprises or is made of a glass fiber filled polymer composite. In some embodiments, the first skin is made of a sheet molded compound (CMC) molded under compression. Such a composite or CMC may include thermoplastic polymers such as polyvinyl chloride (PVC) and polyesters, other than thermosetting (i.e., crosslinking) polymers. Such a composite or CMC may include glass fibers or other minerals or fillers.

On the interior side of the door skin 110, the door skin 110 comprises protrusions 117 and recessions 127 for interlocking structure as described above.

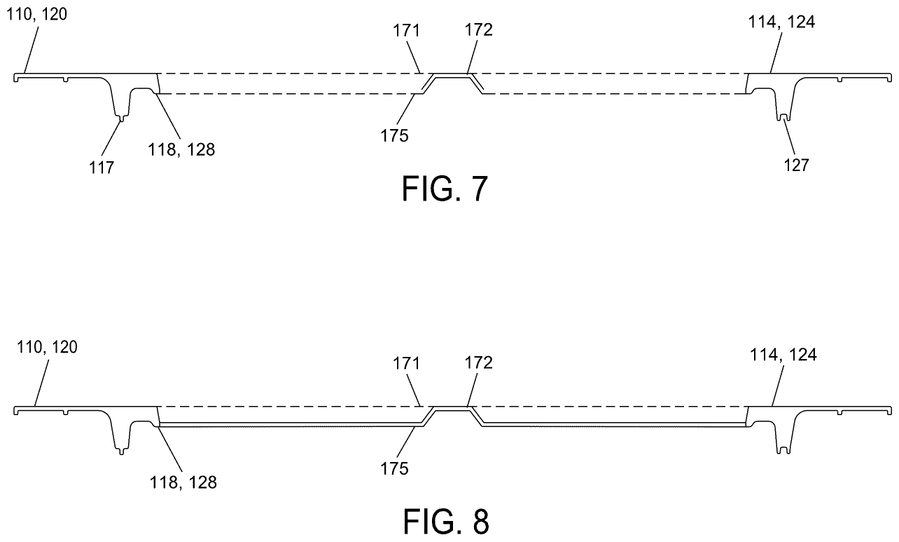

Referring to FIGS. 7 and 8, which are sectional views along A-A′ and B-B′ as shown in FIG. 6A, respectively, in some embodiments, the first door skin 110 including the SDL bars 170 shares a same exterior surface, i.e., the first outer (e.g., exterior) door surface 114. Similarly, the second skin 120 including the SDL bars 170 also share a same exterior surface, i.e., the second outer (e.g., exterior) door surface 124. The at least one intersecting joint 172 in the SDL bars 170 has an outer joint surface 171, which is on the same plane as the first outer door surface 114, 124. The height relative to a bottom surface 175 of the SDL bars is kept the same from the body portion of each skin to the intersecting joint 172. In some embodiments, the bottom surface 175 is configured to be adjacent to or contact the glass unit. So the bottom surface 175 is at the same level as the tips 118, 128. The hollow and open configuration for the intersecting joint 172 as shown in FIGS. 7-8 is for illustration only. The bottom of the intersecting joint 172 is open. The intersecting joint may have other configuration such as a closed hollow structure or a solid structure. In a closed hollow structure, the bottom of the intersecting joint 172 may be closed while the middle of the intersecting joint is hollow.

Referring to FIGS. 9A-9D, a preferred skin structure is illustrated in accordance with some embodiments. FIGS. 9A-9B are sectional views along A-A′ and B-B′ as shown in FIG. 6A, respectively. FIGS. 9C-9D are magnified views of a portion of FIGS. 9A-9B, respectively. In the SDL bars 170, the at least one intersecting joint 172 in the SDL bars 170 has an outer joint surface 171, which is lower than the first outer door surface 114, 124 relative to a bottom surface 175 of the SDL bars 170. The bottom surface 175 is configured to be an interior surface facing the glass unit and be disposed adjacent to or contact an outer surface of the glass unit 130.

The at least one intersecting joint 172 in the SDL bars 170 is not on the same plane as the skin surface, i.e., the outer door surface 114, 124. The height (or thickness) of the SDL relative to a bottom surface 175 of the SDL bars 170 is not the same from the body portion of each skin to the intersecting joint 172. In some embodiments, the set of the SDL bars 170 has a profile with a gradual decrease in a bar surface relative to the bottom surface 175 of the SDL bars (or the glazing unit 130) from the outer joint surface 114, 124 to the outer joint door surface 172. The height or thickness also gradually decreases toward the intersecting joint 172. The hollow and open configuration for the intersecting joint 172 as shown in FIGS. 9A-9B is for illustration only. The intersecting joint 172 may have other configuration such as a closed hollow structure or a solid structure as described in FIGS. 7-8.

Referring to FIGS. 9C and 9C, the gap indicated with “h” represents the difference in the height (or thickness) of the SDL bars 190 relative to a bottom surface 175 from the tip 118, 128 of the body portion of each skin to the intersecting joint 172. A small angle, shown as “a,” exist between the plane of the skin 110, 120 (i.e., the exterior door surface 114, 124) and the cross-sectional profile of a SDL bar from the tip 118, 128 of the body portion of each skin to the intersecting joint 172.

The gap (h) may be of any suitable value. For example, in some embodiments, the gap (h) may be in a range of from 0.5% to 20% such as from 1% to 20%, from 1% to 15%, from 1% to 10%, from 1% to 5%, or from 2% to 15% or any other suitable ranges, of the maximum thickness of the SDL bars. The small angle (a) may be also of any suitable value. For example, in some embodiments, the small angle may be in a range of from 0.1 degree to 15 degree such as from 0.1 degree to 10 degree, from 0.1 degree to 8 degree, from 0.1 degree to 5 degree, from 0.1 degree to 3 degree, from 0.1 degree to 2 degree, or any other suitable range.

In FIGS. 9A-9D, one intersecting joint 172 is shown. The intersecting joint may or may not be the one in the middle of the glazing unit. When the SDL bars 170 have more than one joints 172, the profile height (or thickness) may decrease around the joints 172 and increase to be on the plane of the skin 110, 120 (i.e., the exterior door surface 114, 124). The cross-sectional profile of the SDL bars may have a repeating pattern. In some embodiments, a plurality of intersecting joints 172 may have the same configuration and height.

Using the skins having SDL bars with the unique configuration, it is surprisingly found that such SDL bars provides good contact and compression against the glass unit in an assembled door. The bottom surface 175 of the SDL bars is configured to be disposed onto and contact an outer surface of the glass unit 130. It provides good sealing without trapping any dirt. In some embodiments, no adhesive or sealant is needed for bonding or sealing the SDL bars onto the glass unit. The products provided in the present disclosure solve the problems described in the Background. The door installation process is relatively easy and less costly. The doors provide good performance and durability.

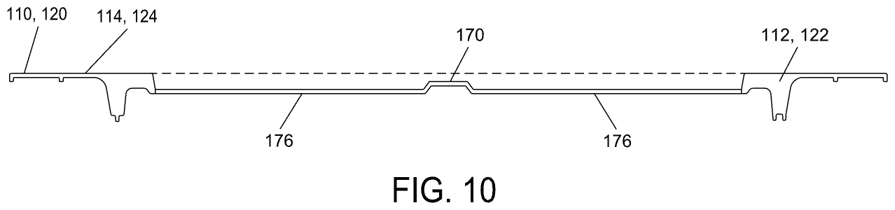

Referring to FIG. 10, in some embodiments, the first or second skin 110, 120 is made by molding the first or second skin, including the respective skin body portion 112, 122 and a respective middle portion 176, in a unitary structure. The middle portion 176 is then cut to provide SDL bars 170 as described above. In some embodiments, each skin is molded from a glass fiber filled polymer composite. Each skin is made of a sheet molded compound (CMC) molded under compression. The CMC or composite includes or is made of glass fiber and a thermoplastic polymer.

In another aspect, the present disclosure also provides a kit for making a door as described herein. Such a kit comprises a first skin 110, a second skin 120, and a glazing unit 130 as described herein. The first skin 11 and the second skin 120 comprise the simulated divided lite (SDL) bars 170 as described. Each of the first skin 110 and the second skin 120 has a unitary structure. The SDL bars and the skin body portion are made of a same material. The two skins may have the same size. The first set of the SDL bars and the second set of the SDL bars may be of a same size and a same pattern, and are configured to match with each other on two sides of the glazing unit so as to define one or more lite sections for exposing the one or more glass panes in the glass unit 130. The first skin and the second skin may further comprise the flange portions for forming an interlocking structure as described herein. In some embodiments, each of the first skin 110 and the second skin 120 comprises a glass fiber filled polymer composite. Each of the first skin 110 and the second skin 120 is made of a sheet molded compound (CMC) molded under compression.

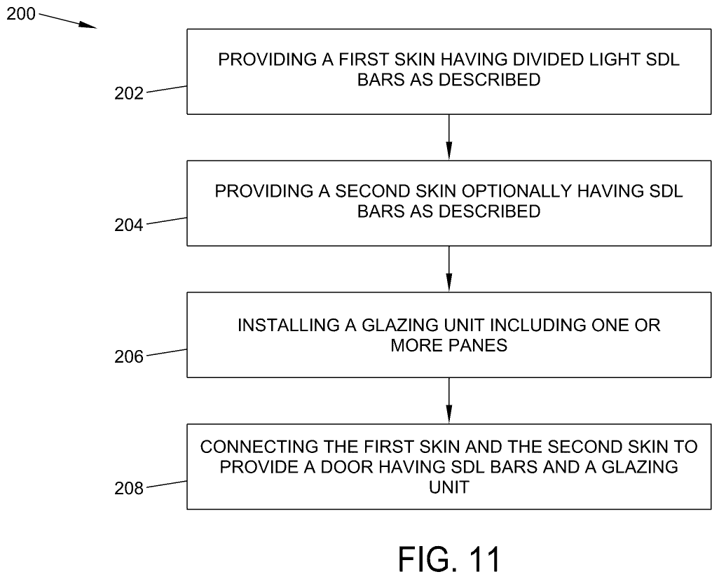

Referring to FIG. 11, an exemplary method 200 is used for making a door 100 in accordance with some embodiments.

At step 202, a first skin 110 as described is provided. For example, the first skin 110, including the first skin body portion 112, the SDL bars 170, and the first flange portion 116, is a unitary molded structure. Similarly, at step 204 a second skin 120 as described is provided.

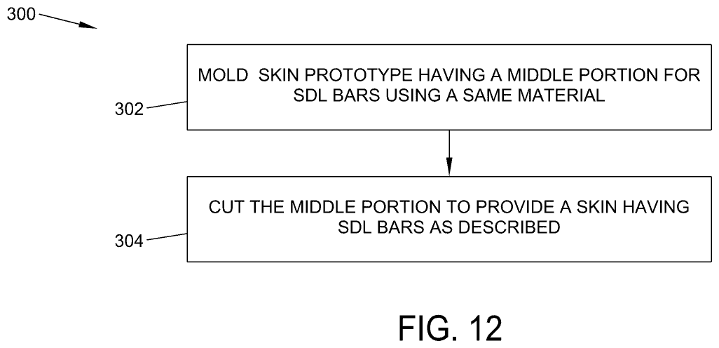

Referring to FIG. 12, in some embodiments, step 202 or 204 may include two steps 302 and 304 as show in the exemplary method 300. At step 202, a porotype for the first or second skin is molded. As illustrated in FIG. 10, such a porotype includes the respective skin body portion 112, 122 and a respective middle portion 176, in a unitary structure.

At step 204, the middle portion 176 is then cut to provide SDL bars 170 having the configurations as described above. After cut, the middle portion 176 including the cut-out portions also defines an opening 131 for accepting the glazing unit 130.

In some embodiments, the middle portion or portions 176 are cut to provide the opening among SDL bars. The cutting is done using a suitable method such as a CNC (computer numerical control) machine with router bits, or by using punching dies with presses, or by water jet, or any combination thereof.

In some embodiments, each skin is molded from a glass fiber filled polymer composite. Each skin is made of a sheet molded compound (CMC) molded under compression. The CMC or composite includes or is made of glass fiber and a thermoplastic polymer.

Referring back to FIG. 11, at step 206, the glazing unit 130 is installed between the first skin 110 and the second skin 120.

At step 208, the first skin 110 and the second skin 120 are connected so as to provide a door comprising SDL bars 170 and the glazing unit 130.

Adhesive or sealant 148 as described above may be optionally applied.

As described above, the first skin 110 and the second skin 120 are connected to provide the interlocking structure 150, through the structures such as protrusion 117 and recess 127 as described above.

The exemplary door 100 provided in the present disclosure may have a rectangular shape with stiles (not shown) aligned vertically along two vertical edges of the door and rails (not shown) aligned horizontally along two horizontal edges of the door. A quadrilateral frame may be used in some embodiments. Such a door frame may be formed of a top rail, a bottom rail, a right stile and a left stile joined together to form said frame. In some embodiments, the door 100 comprises a top rail, a bottom rail, a right stile and a left stile joined together to form a frame quadrilateral door frame. The skins 110, 120 are joined together through the interlocking structure 150 of the flange portions 116, 126. The two skins may be bonded to the rails and stiles. The method 200 may also comprise steps of assembling stiles and rails, and bonded skins to the stiles and rails.

In some embodiments, no external window frame members are used to secure the glazing unit 130 to the skins 110, 120. The edge of the glazing unit is disposed adjacent to and between the first tip and the second tip without an external frame member for connecting each of the first skin, the second skin, and the glazing unit. No exterior window frame is used to join the skins together or install the glazing unit into the space between the tips of the skins.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A door comprising:
a first skin including a first skin body portion providing a first outer door surface, the first skin body portion having a first tip and comprising a first set of simulated divided lite (SDL) bars connected with the first tip;
a second skin including a second skin body portion providing a second outer door surface, the second skin body portion having a second tip and comprising a second set of SDL bars connected with the second tip; and
a glazing unit including one or more glass panes, the glazing unit having an edge disposed adjacent to, and between, the first tip and the second tip, and between the first set of SDL bars and the second set of SDL bars,
wherein each of the first set of the SDL bars and the second set of the SDL bars comprises one or more first bars oriented in a first direction and one or more second bars oriented in a second direction different from the first direction, the one or more first bars and the one or more second bars share at least one intersecting joint, the at least one intersecting joint having an outer joint surface lower than the first outer door surface relative to a bottom surface of the SDL bars configured for contacting the glazing unit,
wherein each of the first skin and the second skin has a unitary structure, the first set of SDL bars and the first skin body portion are made of a same material, and the second set of SDL bars and the second skin body portion are made of the same material.

2. The door of claim 1, wherein in each of the first set of the SDL bars and the second set of the SDL bars, the second direction is normal to the first direction.

3. The door of claim 1, wherein each of the first set of the SDL bars and the second set of the SDL bars is in a grid pattern.

4. The door of claim 1, wherein the first set of the SDL bars and the second set of the SDL bars are of a same size and a same pattern, and are configured to match with each other on two sides of the glazing unit so as to define one or more lite sections for exposing the one or more glass panes in the glass unit.

5. The door of claim 1, wherein each of the first set of the SDL bars and the second set of the SDL bars has a profile with a gradual decrease in a bar surface relative to the glazing unit from the outer joint surface to the outer joint door surface.

6. The door of claim 1, wherein the first skin further comprises a first flange portion connected with and extending inwardly from the first skin body portion, the second skin further comprises a second flange portion connected with and extending inwardly from the second skin body portion, the first flange portion and the second flange portion have a protrusion or recess at each end and are interconnected so as to provide at least one interlocking structure.

7. The door of claim 6, wherein the first flange portion has alternating protrusions and recesses, the second flange portion has corresponding alternating recesses and protrusion, and the at least one interlocking structure comprises alternating male/female interlocking structures.

8. The door of claim 1, wherein each of the first skin and the second skin comprises a glass fiber filled polymer composite.

9. The door of claim 1, wherein each of the first skin and the second skin is made of a sheet molded compound (CMC) molded under compression.

10. A door skin configured to be used for making a door comprising a glazing unit including one or more glass panes, comprising:
a first skin body portion providing a first outer door surface, the first skin body portion having a first tip and comprising a first set of simulated divided lite (SDL) bars connected with the first tip,
wherein the first tip and the first set of SDL bars are configured to be disposed adjacent to and contact the glazing unit,
wherein the first set of the SDL bars comprises one or more first bars oriented in a first direction and one or more second bars oriented in a second direction different from the first direction, the one or more first bars and the one or more second bars share at least one intersecting joint, the at least one intersecting joint having an outer joint surface lower than the first outer door surface relative to a bottom surface of the first set of the SDL bars,
wherein the first skin has a unitary structure, the first set of SDL bars and the first skin body portion are made of a same material.

11. The door skin of claim 10, wherein the second direction is normal to the first direction, and the first set of the SDL bars is in a grid pattern.

12. The door of claim 10, wherein the first set of the SDL bars has a profile with a gradual decrease in a bar surface relative to the glazing unit from the outer joint surface to the outer joint door surface.

13. The door skin of claim 10, wherein the first skin comprises a glass fiber filled polymer composite.

14. The door skin of claim 10, wherein the first skin is made of a sheet molded compound (CMC) molded under compression.

15. A kit for making a door, comprising:
a first skin including a first skin body portion providing a first outer door surface, the first skin body portion having a first tip and comprising a first set of simulated divided lite (SDL) bars connected with the first tip;
a second skin including a second skin body portion providing a second outer door surface, the second skin body portion having a second tip and comprising a second set of SDL bars connected with the second tip; and
a glazing unit including one or more glass panes, the glazing unit having an edge shaped and sized to be disposed adjacent to, and between, the first tip and the second tip, and between the first set of SDL bars and the second set of SDL bars,
wherein each of the first set of the SDL bars and the second set of the SDL bars comprises one or more first bars oriented in a first direction and one or more second bars oriented in a second direction different from the first direction, the one or more first bars and the one or more second bars share at least one intersecting joint, the at least one intersecting joint having an outer joint surface lower than the first outer door surface relative to a bottom surface of each of the first set of the SDL bars and the second set of the SDL bars,
wherein each of the first skin and the second skin has a unitary structure, the first set of SDL bars and the first skin body portion are made of a same material, and the second set of SDL bars and the second skin body portion are made of the same material.

16. The kit of claim 15, wherein in each of the first set of the SDL bars and the second set of the SDL bars, the second direction is normal to the first direction, and each of the first set of the SDL bars and the second set of the SDL bars is in a grid pattern.

17. The kit of claim 15, wherein the first set of the SDL bars and the second set of the SDL bars are of a same size and a same pattern, and are configured to match with each other on two sides of the glazing unit so as to define one or more lite sections for exposing the one or more glass panes in the glass unit.

18. The kit of claim 15, wherein the first skin further comprises a first flange portion connected with and extending inwardly from the first skin body portion, the second skin further comprises a second flange portion connected with and extending inwardly from the second skin body portion, the first flange portion and the second flange portion have a protrusion or recess at each end and are interconnected so as to provide at least one interlocking structure.

19. The kit of claim 15, wherein each of the first skin and the second skin comprises a glass fiber filled polymer composite.

20. The kit of claim 1, wherein each of the first skin and the second skin is made of a sheet molded compound (CMC) molded under compression.

21. A method for making the door of claim 1, comprising:
providing the first skin;
providing the second skin;
installing the glazing unit between the first skin and the second skin; and
connecting the first skin and the second skin so as to provide a door comprising SDL bars and the glazing unit.

22. The method of claim 21, wherein the first or second skin is provided by:
molding the first or second skin including the respective skin body portion and a middle portion in a unitary structure; and
cutting the middle portion to provide SDL bars.

23. The method of claim 21, wherein each of the first skin and the second skin is molded from a glass fiber filled polymer composite.

24. The method of claim 21, wherein each of the first skin and the second skin is made of a sheet molded compound (CMC) molded under compression.
